(19) United States
(12) Patent Application Publication
(10) Pub. No.: US 2009/0261160 A1
(43) Pub. Date: Oct. 22, 2009

(54) Systems and Methods for Enabling Distribution of Co-Branded Debit Cards

(76) Inventors: Richard Rozbicki, Danbury, CT (US); Wade Plummer, Chicago, IL (US)

Correspondence Address: BAKER BOTTS L.L.P., 30 ROCKEFELLER PLAZA, 44TH FLOOR, NEW YORK, NY, 10112-4498, US

(21) Appl. No.: 12/341,524

(22) Filed: Dec. 22, 2008

Related U.S. Application Data
(60) Provisional application No. 61/016,003, filed on Dec. 21, 2007.

(51) Int. Cl. G06K 5/00

(52) U.S. Cl. 235/380

(57) ABSTRACT

In accordance with the present invention, systems and methods for enabling distribution of co-branded debit payment tokens are provided. The systems and methods, which may include a franchising party entering into an arrangement with a co-brand partner and assembling a group of one or more banks to participate in co-branding of the co-branded debit payment tokens where one or more of the banks in the group distribute the co-branded debit payment tokens are disclosed herein.

### CROSS-REFERENCE TO RELATED APPLICATION

This application claims the benefit of U.S. provisional patent application No. 61/016,003, filed on Dec. 21, 2007, which is incorporated by reference in its entirety.

### BACKGROUND OF THE INVENTION

The introduction and popularization of payment cards (e.g., credit cards, ATM and debit cards, charge cards, contactless payment devices of various card and non-card form factors, etc.) has been one of the most significant changes in the way people can pay for goods and services in the modern economy. Payment-by-card transactions are often more convenient and more secure than paper-based payment processes.

The use of payment tokens or devices that are linked to customer accounts (e.g., credit cards, debit cards, charge cards, smart cards, contactless payment devices of various card and non-card form factors, etc.) is commonplace for conducting financial transactions in the modern economy. The payment-by-card industry involves many different entities (e.g., card issuers, merchant acquirers, payment processors, etc.) that perform various tasks for processing payment-by-card transactions (i.e., handling the information and payment flows needed for converting an electronic record created at the point of sale into cash for the merchant). FIG. 1 shows an exemplary four-party network involved in processing payment-by-card transactions including transaction authorization, and clearing and settlement.

Debit tokens are the cornerstone of the retail banking relationship. These tokens offer both convenience and financial control by combining the worldwide acceptance and benefits of credit cards, with an immediate deduction of funds from the user's checking or savings account. Unlike credit tokens, such as credit cards, debit tokens are predominantly a locally-based product, based on local banking relationships and local distribution, and as such, their market penetration is mainly local. While credit card issuers often enter into co-branding partnerships with non-banking entities such as merchants, debit token programs do not presently benefit from these relationships. Among other benefits, co-branding programs offer merchants the opportunity to provide customers with an expanded-utility payment vehicle that carries the merchant's indicia (e.g., logo or brand) side-by-side with the issuer's brand. Issuers also benefit through co-branding relationships. For example, co-branding provides a new product offering to differentiate them from their competitors, and the enhanced value proposition to retail customers allows for increased user loyalty.

Consideration is now being given to ways of enhancing systems and methods for enabling distribution of co-branded debit payment tokens.

### SUMMARY

In accordance with the present invention, systems and methods for enabling distribution of co-branded debit payment tokens or devices are provided.

The systems and methods, which may include a franchising party entering into an arrangement with at least one non-bank co-branding entity and assembling a group of one or more banks to participate in co-branding of the co-branded debit payment tokens or devices where one or more of the banks in the group distribute the co-branded debit cards are disclosed herein.

In some embodiments, these banks may be chosen such that they have a substantially non-overlapping geographical presence. The system and method may also include the use of program design components, licensing components, data analytics components, and management components. These can be used to design value propositions, program requirements and restrictions, and the size and geographical coverage of the card distribution program. They can also be used to establish a licensing process for tokens or devices issued in the distribution program. Establishing the licensing program can include establishing market areas, branding rules, and minimum service standards for the program. The franchising party can provide data analytics, based on information from the issuing party, to the co-branding partners. The system and method can also include the use of a points/customer reward program.

Further features of the invention, its nature and various advantages will be more apparent from the accompanying drawings and the following detailed description.

### BRIEF DESCRIPTION OF THE DRAWINGS

FIG. 1 is a schematic illustration of a four-party network for processing payment card transactions.

FIG. 2 is a block diagram illustrating the components of an exemplary system, which can be used for co-branding, in accordance with the present invention.

FIG. 3 is a block diagram showing the components of an exemplary method, which can be used for co-branding, in accordance with the present invention.

### DETAILED DESCRIPTION

The present invention is described in the context of the debit cards or devices with the understanding that the inventive principles of the present invention are applicable to other financial payment tokens. Systems and methods for enabling distribution of co-branded debit payment tokens are provided.

In an exemplary system and method for enabling distribution of co-branded debit, a franchising party, such as MasterCard® International Inc. (“MasterCard”), will partner with one or more co-branding partners (e.g., merchants) to define and package their co-brand debit product. Along with their co-brand partners, the franchising party will define and package the following aspects of their co-brand debit product: value proposition, requirements and restrictions for issuer participants, the size of the co-branding program, and geographical coverage of the program. The value proposition will be beneficial to both the co-brand partners and card issuers.

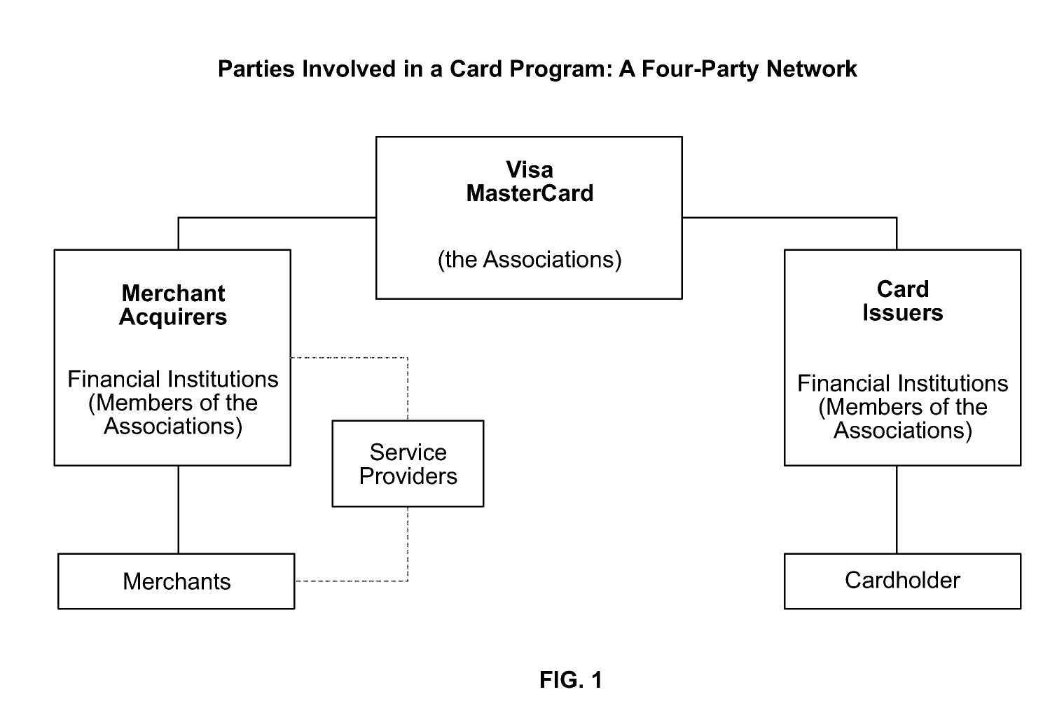

FIG. 1 shows a four-party network for processing payment card transactions. In addition to a franchising party, transaction processing can involve four participants: issuers (e.g., the cardholders' banks), merchants, acquirers (e.g., the merchants' banks), and cardholders.

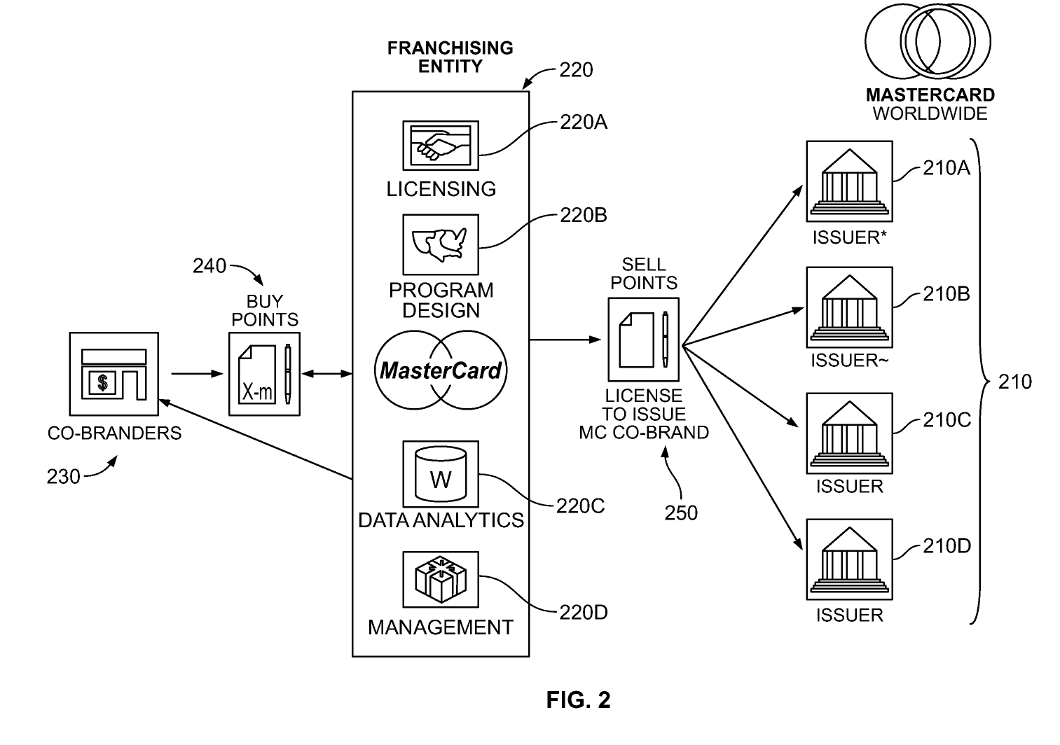

FIG. 2 shows the relationships between the parties in an exemplary co-branding system 200. The parties can include issuers 210 (e.g., banks 210A-D), a franchising party 220, co-branders 230, points 240, and licenses 250. Franchising party 220 can include several sub-components. For example, it can include licensing components 220A, program design components 220B, data analytics components 220C, and management components 220D.

Licensing component 220A can allow the franchising party 220 to establish a licensing process for debit payment tokens or devices (e.g., debit cards) issued in this program. Licensing component 220A can allow a process which may include establishing market areas, establishing branding rules, and establishing minimum service standards. Franchising party 220 can establish these with co-branders 230 and may monitor minimum standards based on an agreed-upon service level.

Program design components 220B can allow franchising party 220 to define and group the various aspects of the co-branded debit product. For example, program design components 220B allow the franchising party to define and group value proposition, requirements and restrictions for issuers 210, the size of the co-branding program, and geographical coverage of the program. Program design components 220B can also be used to ensure that the program design for the co-branded payment tokens or devices (e.g., debit cards) is consistent between parties involved in the co-branding. Additionally, program design components 220B can be used to assemble a group of issuers 210 to participate in the distribution of the co-branded debit payment tokens or devices. Issuers 210 may be chosen such that they have a substantially non-overlapping presence and may also have substantially non-overlapping distribution rights.

Value propositions may apply to both co-branders 230 and issuers 210. Regarding merchant value propositions, co-branders 230 appreciate the growing importance of debit in the marketplace and can recognize the benefits of entering a co-branding agreement. They realize that an increasingly large portion of customer card spending is going to debit, but they currently have few means to create loyalty and generate incremental revenue from these customers. The designed value proposition can make the potential benefits (e.g., greater brand extension, additional business, enhanced spending reporting) of co-branding clear to potential co-branders 230 (e.g., merchants). As an example of a possible benefit to potential co-branders, the payment tokens may bear indicia (e.g., logo or brand) of the co-branding partner.

As for issuer value propositions, issuers 210 (e.g., banks) also realize appreciate the growing importance of debit in the marketplace and through the use of the value proposition, franchising party 220 can help banks recognize the benefits of entering an agreement to issue co-branded debit payment tokens or devices (e.g., debit cards). Banks realize that co-branded cards are expected to generate 2 to 3 times the spending of non-co-branded cards and have significantly lower attrition rates than non-co-branded products. Currently most banks lack the resources and portfolio size to attract desired merchant partners or develop and manage a program. Additionally, due to economies of scale and overhead associated with creating and managing a co-brand debit card program, most programs would not be worthwhile for banks financially if they acted alone. The designed value proposition can address these issues and make these and other potential benefits of co-branding clear to banks that may potentially issue the co-branded debit payment tokens or devices.

Data analytics components 220C allow franchising party 220 to provide data analytics. The analytics can be based on transactional information from issuers 210 and provided to co-branders 230. If desired, data analytics components 220C can be used to provide data analytics across all the issuers in the program. This data may be used to develop targeted promotional programs for both the co-branders 230 and issuers 210.

Management component 220D allows franchising party 220 to manage various aspects of the co-branding system. For example, it may allow the franchising party 220 to manage points 240 which may be used as part of a user-reward and/or loyalty management program, rewarding cardholders for their loyalty. In certain embodiments, this program can be integrated across all the issuers 210 in the co-branding coalition or group.

Regarding points management, the franchising party 220 can buy points and sell them to issuers 210. Alternatively, the franchising party 220 can use the management component 220D to establish a mechanism or market for the purchase and sale of points 240. Each issuer 210 could be required to score and submit purchase calculation point files on a periodic basis (e.g., daily). The franchising party 220 can then score purchases for point totals and interface with the various co-branders 230 to accomplish the necessary point transfers.

The franchising party 220 can also use the management component 220D to manage the co-brand relationship directly and franchise issuing rights. The issuing rights may be issued based on market area. The managing component may also allow the franchising party to manage issuance across multiple other types of entities (e.g., branding controls and points management). If desired, the franchising party 220 can be responsible for communications between co-branders 230 and issuers 210 and act as a single point of contact between the parties.

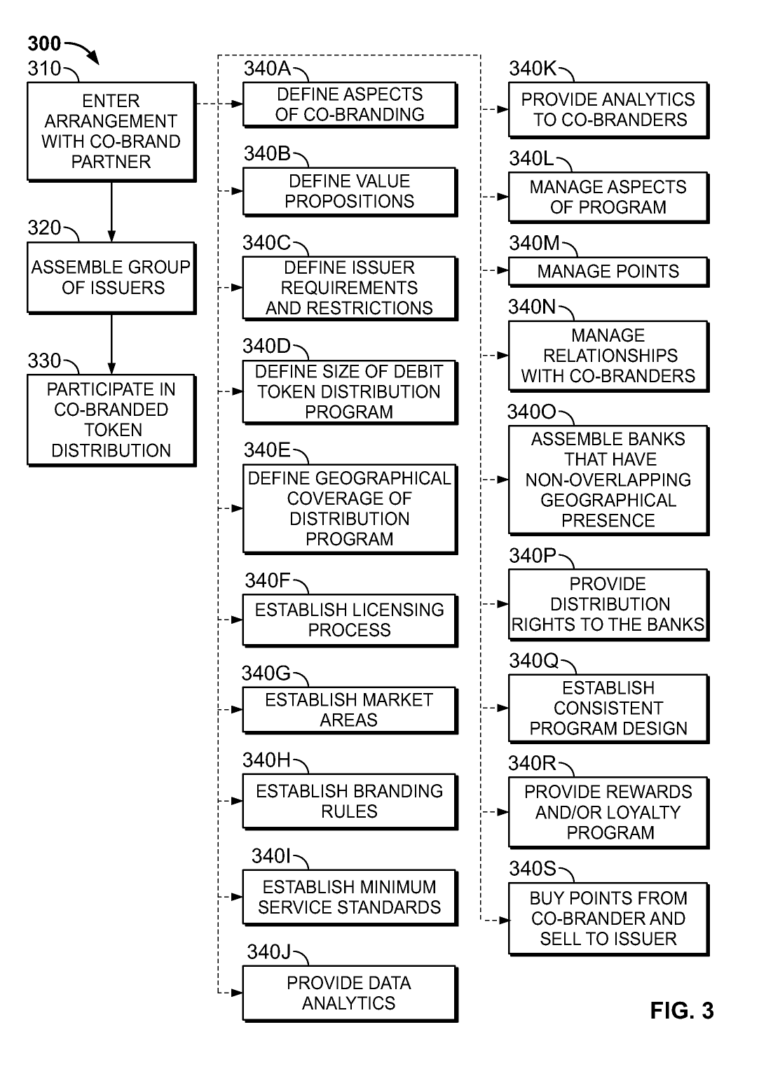

FIG. 3 shows the exemplary steps of an inventive co-branding process 300 which can use the system components described above. The parties can include issuers 210 (e.g., banks 210A-D), a franchising party 220, co-branders 230, points 240, and licenses 250. Franchising party 220 can use several sub-components. For example, it can use licensing components 220A, program design components 220B, data analytics components 220C, and management components 220D.

In process 300, at step 310, the franchising party 220 enters into an arrangement with a co-brand partner. At step 320, the franchising party 220 assembles a group of one or more issuers 210 (e.g., banks) to participate in the co-branding of the co-branded debit payment tokens or devices (e.g., cards). At step 330, one or more of the issuers 210 participating in the co-branding of the co-branded debit cards distributes said co-branded debit payment tokens or devices.

Process 300 may also include one or more optional steps 340A-S. At step 340A, program design components 220B are used to define aspects of the co-branding program. At step 340B, program design components 220B are used to design value propositions as part of the co-branding program. At step 340C, program design components 220B are used to define requirements and restrictions for issuers 210 that participate in the co-branding of the co-branded debit payment tokens or devices (e.g., cards) as part of the co-branding program. At step 340D, program design components 220B are used to define the size of the debit payment token or device distribution program. At step 340E, program design components 220B are used to define the geographical coverage of the debit payment tokens or device distribution program. At step 340F licensing components 220A are used to establish a licensing process for tokens or devices issued in the distribution program. At step 340G, licensing components 220A are used to establish market areas for licensing tokens or devices issued in the debit token or device distribution program. At step 340H, licensing components 220A are used to establish branding rules for cards issued in the debit payment token or device distribution program. At step 3401, licensing components 220A are used to establish minimum service standards for the debit payment token or device distribution program. At step 340 J, data analytics components 220C are used to provide data analytics. The data analytics are based on transactional information from issuers and are sent to co-brand partners. At step 340K, data analytics components 220C are used to provide data analytics across issuers 210 to co-branders 230. At step 340L, management components 220D are used to manage aspects of the co-branding program. At step 340M, management components 220D are used to manage points 240. These points 240 may be used as part of a user-reward and/or loyalty management program, rewarding cardholders for their loyalty. At step 340N, management components 220D are used to manage relationships with co-branders 230. At step 340O, the franchising party 210 assembles banks that have a non-overlapping geographical presence to participate in the co-branding of the debit payment tokens or devices. At step 340P, the franchising party provides distribution rights to banks in the program. Distribution rights are arranged such that they do not substantially overlap geographically. At step 340Q, the franchising party and co-branders 230 establish a consistent program design for the co-branded debit payment tokens or devices. At step 340R, the franchising party provides a rewards and/or loyalty management program. This program is integrated across all the issuers 210 participating in the co-branding. At step 340S, the franchising party buys points from a co-brander 230 and sells the points to issuers 210 in the co-branding group.

Although the present invention has been described in connection with specific exemplary embodiments, it should be understood that various changes, substitutions, and alterations apparent to those skilled in the art can be made to the disclosed embodiments without departing from the spirit and scope of the invention. For example, steps in process 300 have been described in a particular order, but it is readily understood that these steps may be performed in any suitable order. Other steps may be added or some steps may be excluded.

We claim:

1. A method for processing transactions conducted using a co-branded debit token, comprising:
creating a co-branded debit program including at least one non-bank co-branding entity and at least two banks, each of said at least two banks having a plurality of respective customers;
issuing a plurality of co-branded debit payment tokens bearing indicia associated with said non-bank co-branding entity to said customers;
processing via a financial transaction network, financial messages associated with debit transactions conducted using said co-branded debit tokens.

2. The method of claim 1, further comprising using program design components to define aspects of the co-branded debit program.

3. The method of claim 2, further comprising using said program design components to design value propositions.

4. The method of claim 2, further comprising using said program design components to define requirements and restrictions for said banks.

5. The method of claim 2 further comprising using said program design components to define the size of the co-branded debit program.

6. The method of claim 2 further comprising using said program design components to define the geographical coverage of the co-branded debit program.

7. The method of claim 1, further comprising licensing components to establish a licensing process for tokens issued in the co-branded debit program.

8. The method of claim 7, further comprising using said licensing components to establish market areas for licensing tokens issued in the co-branded debit program.

9. The method of claim 7, further comprising using said licensing components to establish branding rules for tokens issued in the co-branded debit program.

10. The method of claim 7, further comprising using said licensing components to establish minimum service standards for the co-branded debit program.

11. The method of claim 1, further comprising using data analytics components to provide data analytics, said analytics based on transactional information from said banks, to co-branding entities.

12. The method of claim 1, further comprising using data analytics components to provide data analytics across banks in said coalition to co-branding entities.

13. The method of claim 1, further comprising using management components to manage aspects of the co-branded debit program.

14. The method of claim 13, further comprising using management components to manage points.

15. The method of claim 13, further comprising using management components to manage relationships with said co-branding entities.

16. The method of claim 1, wherein creating said debit program comprises assembling a coalition or group of banks that have a substantially non-overlapping geographical presence.

17. The method of claim 1, wherein creating said debit program further comprises providing substantially non-overlapping geographical token distribution rights to the banks in said program.

18. The method of claim 1, further comprising establishing a consistent program design for the co-branded debit card distribution.

19. The method of claim 1, further comprising providing a rewards and/or loyalty management program that is integrated across all the banks in the program.

20. The method of claim 19, further comprising buying points from the co-branding partner and selling points to the banks within the group.

21. A system for processing transactions conducted using a co-branded debit token, comprising:
a plurality of co-branded debit tokens bearing indicia of at least one non-bank co-branding entity, each token issued by one of at least two distinct banks;
at least one financial message processing computer associated with at least one of said at least two distinct banks; and
a debit financial message processing device for routing an electronic financial message to one of said at least one financial message processing computer.

22. The system of claim 21, wherein said debit tokens are associated with a co-branded debit token program having program design components.

23. The system of claim 22, wherein said design components include design value propositions.

24. The system of claim 22, wherein said design components define requirements and restrictions for said banks.

25. The system of claim 22 wherein said design components define the size of a co-branded debit token program.

26. The system of claim 22 wherein said design components define the geographical coverage of a co-branded debit token program.

27. The system of claim 21, wherein said debit tokens are associated with licensing components that establish a licensing process for tokens issued in a co-branded debit token program.

28. The system of claim 27, wherein said licensing components establish market areas for tokens issued in a co-branded debit token program.

29. The system of claim 27, wherein said licensing components establish branding rules for tokens issued in a co-branded debit token program.

30. The system of claim 27, wherein said licensing components establish minimum service standards for a co-branded debit token program.

31. The system of claim 21, wherein said debit tokens are associated with data analytics components that provide data analytics, said analytics based on transactional information from said banks, to said co-branding entities.

32. The system of claim 21, wherein said debit tokens are associated with data analytics components that provide data analytics across said banks in said coalition to co-branding entities.

33. The method of claim 21, wherein said debit tokens are associated with management components that manage aspects of a co-branding debit token program.

34. The system of claim 33, wherein said management components manage points.

35. The system of claim 34, wherein said management components manage relationships with co-branding entities.

36. The system of claim 21, wherein said distinct banks have a substantially non-overlapping geographical presence.

37. The system of claim 21, wherein said distinct banks have substantially non-overlapping geographical token distribution rights.

38. The system of claim 21, wherein said debit tokens are associated with a co-branded debit token program with a consistent program design.

39. The system of claim 21 said debit tokens are associated with a co-branded debit token program having a rewards and/or loyalty management program that is integrated across all of said distinct banks.

40. The system of claim 21, wherein said at least one financial message processing computer assigns a quantity of loyalty points purchased from said non-bank co-branding entity to at least one account associated with at least one of said plurality of co-branded debit tokens.
